(19) United States
(12) Patent Application Publication
(10) Pub. No.: US 2013/0132121 A1
(43) Pub. Date: May 23, 2013

(54) Flexible varying premium option for critical illness insurance

(71) Applicant: Robert Yee, San Francisco, CA (US)

(72) Inventor: Robert Yee, San Francisco, CA (US)

(21) Appl. No.: 11/389,416

(22) Filed: Mar. 24, 2006

Related U.S. Application Data
(60) Provisional application No. 60/665,211, filed on Mar. 24, 2005.

(51) Int. Cl. G06Q 40/08; G06Q 50/22

(52) U.S. Cl. CPC G06Q 40/08; G06Q 50/22
USPC 705/4

(57) ABSTRACT

Flexible, varying critical illness insurance premium schedules are determined. Input variables such as issue age, targeted present value and year-to-year premium relationship are supplied, as are some members of a set of process variables. A non-supplied process variable is calculated based on the input variables and the supplied process variables. A premium schedule based on the supplied variables and the calculated process variable is then determined, such that the premium schedule increases (or alternatively decreases) over time to at least one leveling point, at which premiums become level.

### PRIORITY CLAIM

This application claims the benefit under 35 U.S.C. §119(e) of U.S. Provisional Patent Application Ser. No. 60/665,211, filed Mar. 24, 2005, entitled “Long Term Care Insurance, A New Premium Paradigm: Increasing Premiums with Cap at Later Ages,” the entirety of which is incorporated herein by reference. This application is related to co-pending U.S. patent application Ser. No. 11/291,554, filed Nov. 30, 2005, entitled “Flexible Varying Premium Option for Long Term Care Insurance.”

### TECHNICAL FIELD

This invention pertains generally to calculating insurance premium schedules, and more specifically to methodology for providing flexible increasing premium options for critical illness insurance policies.

### BACKGROUND

Critical illness (CI) insurance covers the risks of major diseases and medical conditions such as heart attack, stroke, cancer, renal disease and conditions requiring major organ transplant. Proceeds from the policy can pay for unanticipated expenses relating to loss of income, family support, career change, and treatment cost not covered by medical insurance. The Policy Benefit can be a lump sum, with payments that may vary based on benefit trigger (disease or medical condition), or can be paid in periodic (e.g. monthly) installments. The policy usually terminates when such benefit payments are completed. CI insurance has been marketed successfully in South Africa, the United Kingdom, Canada and Asia in both the individual and group insurance markets. It is beginning to be sold in the United States, especially in the group market.

CI insurance policies typically have premiums payable for life based on the issue age of the insured, with benefit coverage for the lifetime of the insured. Since the risk of acquiring the covered diseases increases with advancing age, the insurance would require ever-increasing premiums if paid based on the attained age cost of the CI risk. Most insureds would be unable to afford this increasing cost. There are group policies with attained age premiums that terminate coverage at retirement, however they may not be desirable since the need for the insurance continues after retirement.

Consequently, a level premium structure that is higher for each older issue age of the insured is typically utilized to address this cost problem. This level premium structure provides for significant pre-funding of the greater cost of claims as people age.

A delay in purchase results in even higher premiums, due to the increase in premiums by issue age and the rising cost of care due to inflation. Additionally, the health status of the purchaser might have worsened, resulting in a rejection of coverage by the insurer. This level premium structure results in relatively high costs at point of purchase, which limits the popularity of CI insurance in the United States, especially for worksite sales.

Attempts to reduce the otherwise high premium costs are available in the form of a reduction in benefit. In order to mitigate the premium cost, many policies reduce the benefit by half at an attained age such as 65 or 70. This feature is generally undesirable for the insured since there is no comparable reduction in risk or cost of care. In fact, the opposite is usually the case—an increasing risk and cost of care.

The expected claims in the early policy years for a particular policy are substantially less than the level premium, and the reverse is true in later years. This accounts for the pre-funding aspect in CI insurance policies. However, the policy has no cash value. The insured would have paid premiums significantly in excess of the costs of coverage if the policy were lapsed during the early years.

Due to the low frequency of claims and the newness of the market, insurers in the United States have virtually no experience with insured parties to determine the premiums accurately. Insurers are subject to long-tailed risks in claim, mortality, policy lapse, investment and expense experience. In general, insurers are reluctant to experiment with new product options.

What is needed are methods for calculating CI insurance premium schedules that are both profitable to insurers and affordable to insured parties across the entire period of coverage. Because an insured's disposable income will rise and fall in fairly predictable ways at different life stages, the schedule should account for such variation.

### SUMMARY OF INVENTION

Methods, computer program products and computer systems calculate flexible, varying CI insurance premium schedules. Input variables such as issue age, targeted present value and year-to-year premium relationship are supplied, as are some members of a set of process variables. A non-supplied process variable is calculated based on the input variables and the supplied process variables. In one embodiment, three of the following four process variables are supplied: a Policy Benefit, an initial premium amount, a leveling point and an ultimate level premium. In that embodiment, the fourth process variable is then calculated based upon the other three and the input variables. A premium schedule based on the supplied variables and the calculated process variable is then determined, such that the premium schedule increases (or alternatively decreases) over time to at least one leveling point, at which premiums become level. The schedule is calculated such that it meets the present and future needs of the buyer, and yet still hits the target present value so that it is profitable to the seller. Leveling points can be dates at which the buyer expects a decrease (or increase) in disposable income, such as retirement, payoff of loans, children entering or graduating from college, etc.

The features and advantages described in this summary and in the following detailed description are not all-inclusive, and particularly, many additional features and advantages will be apparent to one of ordinary skill in the relevant art in view of the drawing, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a block diagram illustrating determining a CI insurance premium schedule with an increasing pattern, according to some embodiments of the present invention.

FIG. 2 is block diagram illustrating a process using a plurality of variables to calculate a CI insurance premium schedule, according to some embodiments of the present invention.

FIG. 3 is diagram illustrating the relative degree of pre-funding for a schedule calculated according to an embodiment of the present invention and a level premium schedule.

The Figure depicts embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

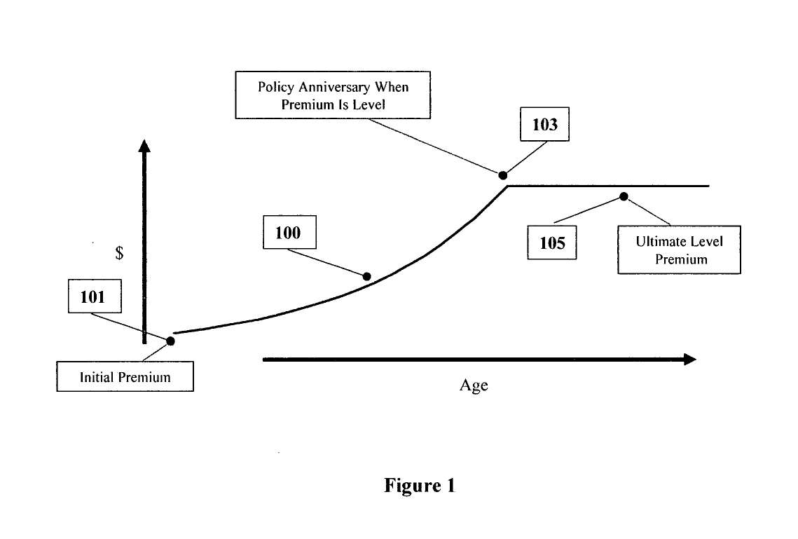

FIG. 1 illustrates a high-level overview of determining a CI insurance premium schedule 100 with an increasing pattern according to one embodiment of the present invention. In the embodiment illustrated in FIG. 1, the schedule begins with an initial premium 101 at the first policy year and uses calculated, incremental pre-funding to increase to a policy anniversary 103 (or other point) at, for example, a pre-determined attained age or policy duration, at which point the premium becomes level 105. The level premium 105 remains in effect from that policy anniversary 103 and thereafter. Through the use of incremental pre-funding early on, the schedule can be leveled at the desired 103 point even though the real cost of the policy increases as the insured party ages.

Premiums will generally become level 105 when the insured party attains an age near normal retirement, after which the insured will be on a relatively fixed income. However, in other embodiments of the present invention, other ages as well as non-age based events can be used to inform the schedule 100 based on the needs of the insured or group. Any anticipated future need of the buyer can be met through the use of pre-funding. For example, the rate of increase can be set to incrementally raise at the time of anticipated events which will raise the buyers level of disposable income (e.g., children graduate from college, home mortgage is paid off), or level off (or alternatively decrease) in accordance with income lowering events, such as retirement, children entering college, etc. Specific premium schedules 100 can be set by the insurers according to various embodiments of the present invention in order to address the needs of various segments of the market. The schedule 100 can range from a simple schedule 100 for the group market that, for example, increases every three years by attained age until age 65 to a more complicated schedule 100 that is customized to an individual applicant in the individual market.

Schedules 100 calculated according to the present invention comprise an alternative to the current issue age level premium pattern. Such schedules 100 do not affect the underlying Policy Benefits. Schedules calculated according to the present invention lower the premiums for the initial policy years below the corresponding level premium of a policy with identical benefits. The ultimate premium will thus be higher than the corresponding level premium.

In some but not all embodiments of the present invention, under a policy generated by the present invention, an insured can choose to reduce the Policy Benefit to a pre-determined amount and pay the premiums at the current level in the future should an unforeseen event occur causing future premiums increases to be unaffordable.

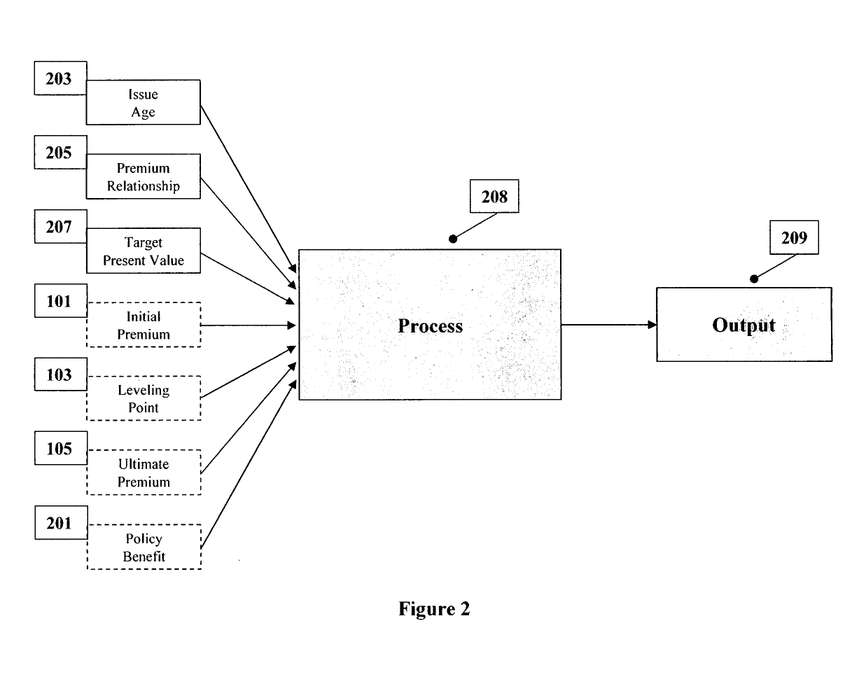

FIG. 2 illustrates the use of a plurality of variables to calculate a premium schedule 100 according to some embodiments of the present invention. Note that the example of FIG. 2 illustrates variables used for calculating a schedule 100 with premiums that are raised until a single leveling point 103, as illustrated in FIG. 1. However, the variables can be adjusted to calculate schedules 100 with multiple leveling points 103 and/or one or more increase or decrease points as desired.

The process of calculating a schedule 100 according to the present invention can utilize the following variables:

1. a Policy Benefit 201;

2. the initial annual premium 101, e.g., payable during the first policy year;

3. the point 103 at which premiums become level (e.g., the policy anniversary at which time premiums become level);

4. the amount of the ultimate level annual premium 105;

5. the issue age 203;

6. the year-to-year premium relationship 205 during the period when premiums are increasing; and

7. a targeted present value 207 of future premiums.

The last three variables 203, 205 and 207 are inputs to a schedule determination process 208 that are specified prior to the schedule 100 calculation. With any three of the first four variables 201, 101, 103, 105 selected, a value 209 for the remaining variable of the first four can be calculated. This output value 209 and the three selected variables define the premium schedule 100 (e.g., in the illustrated example a schedule 100 that increases during a prescribed period and then becomes level). Where more complicated schedules 100 are desired, the variables are adjusted accordingly (e.g., multiple leveling dates, other types of adjustment dates, etc.).

Given the supplied inputs, the first four variables, namely, the Policy Benefit 201, the initial premium 101, the leveling point 103 and the ultimate level premium 105, determine a premium schedule 100. By varying these four factors, a schedule 100 can be developed that meets the budgetary requirement of a potential purchaser. For example, suppose that an initial premium 101 is desired for a specific benefit amount 201, and a specific leveling age 103 is selected. The ultimate level premium 105 is then calculated based on the supplied variables. Alternatively, given an attained age 103 when premiums will become level, an ultimate level premium 105 and a specific plan 201, the initial premium 101 can be solved.

Each of the variables is now described in detail. A Policy Benefit 201 is defined under a CI insurance policy. This amount typically includes benefit payable under any optional riders (such as spouse coverage rider) attached to the basic policy. The Policy Benefit 201 can either be an input to the calculation process 208 or the output 209. For cost and risk reasons, the insurer may impose upper and lower limits on the Policy Benefit 201.

Premiums for CI insurance can be charged separately by underwriting risk class. For example, smokers and non-smokers can have separate premium rates. The initial premium 101 can either be an input to the process 208 or the output 209. As an input, the initial premium 101 is typically expressed as a percentage of the corresponding level premium for a plan with the identical issue age and policy features. Insurers incur considerable costs to acquire a policy. These costs include marketing expenses, underwriting and issue expenses, commissions, risk-based capital, etc. Accordingly, insurers may want to set a minimum on the initial premium 101 in order to recoup the acquisition costs within a reasonable period.

The leveling point 103 (e.g., the policy anniversary when the premium becomes level) can either be an input to the process 208 or the output 209. It can be, for example, any anniversary after issue. In order to make the initial premium 101 relatively low and therefore affordable, insurers may require a minimum number of increasing premium years before premiums become level in the future.

The ultimate level annual premium 105 can either be an input to the process 208 or the output 209.

Issue age 203 affects the amount of premiums since the likelihood of acquiring the covered diseases increases with age. Due to risk and marketing constraints, insurers may establish issue age limits that are different from those for level premium policies.

The premium relationship 205 describes how the premium of one year is related to that of the prior year. Basic patterns are: a constant percentage increase over the premium for the prior policy year, a constant dollar increase over the premium for the prior policy year, and increases at the beginning of regular or irregular intervals but level during the intervals. Any combination of the basic pattern or other increasing patterns is possible. Combinations with current existing premium patterns, such as future premium decreases or limited premium paying periods, are also possible. In order to minimize the potential hardship of paying higher premiums, an insurer may . restrict the amount of the annual increases.

According to its profit goals, the insurer sets a target for the present value of premiums 207. The present value of any increasing premium schedule 100 is then calibrated to meet this target 207. The targeted present value 207 varies by issue age and Policy Benefit. The targeted present value 207 takes into account the expected time value of money and the expected persistency of policies. A discount rate determines the expected time value of money. The discount rate does not necessarily tie to the expected investment return of the assets in the insurer's investment portfolio allocated to its CI insurance business. The persistency assumption consists of a table of expected mortality rates that vary by attained age and a set of expected policy lapse rates .

To determine the targeted present value 207, the insurer starts with the corresponding level premium for the same Policy Benefit 201. It calculates the projected profits based on morbidity, persistency, investment return and expense assumptions. The level premium is adjusted until the desired projected profits are achieved. Then, the present value of the level premiums, calculated using the discount rate, mortality and voluntary lapse rates, is set as the target 207.

Once an insurer gains sufficient experience from sales of insurance schedules 100 calculated according to the present invention, refinements can be applied to help achieve the profit objectives more precisely. For example, instead of using a level premium, the insurer may use an increasing premium schedule 100 that represents the expected average of all the schedules 100 to be generated according to the present invention for a specific issue age 203 and a Policy Benefit 201.

In setting the targeted present value 207, the insurer seeks to strike a balance between desired profit goals and attractiveness of the resulting premium schedules 100 to the potential purchasers. A low target 207 will undermine the profit objectives while a high target 207 will produce an expensive premium schedule 100, which may not compare favorably with the corresponding level premium.

Due consideration is also given to the contingency that the insured can opt to request a freeze in future premiums at the current level with a pre-determined reduction in the Policy Benefit. This feature is a desirable part of a CI insurance policy according to the present invention. The purpose of this option is to mitigate potential lapse by the insured when future premium increases become a financial burden.

The process 208 employs an iterative procedure to compare the targeted present value 207 with the present value of future premiums from the interim premium schedule 100. Once the discounted value of a schedule 100 matches the target 207, that schedule 100 becomes the solution.

It will be readily understood by one of ordinary skill in the relevant art that the steps of this process 208 can be automated (e.g., performed by a computer program) or performed manually. At least for the calculation intensive steps, automation will be far more practical, but is not required. The implementation mechanics of the execution of the steps of the process 208 will be readily apparent to those of ordinary skill in the relevant art in light of this specification.

For purposes of illustration, some examples of calculating schedules 100 according to various embodiments of the present invention follow.

### EXAMPLE 1

A worker age 40 (the issue age 203) who is a non-smoker can afford to pay a $25 initial bi-weekly premium 101 and a $60 ultimate level bi-weekly premium 105 at the policy anniversary at age 55 (the leveling point 103). A schedule 100 of a $25 initial bi-weekly premium 101, increasing 6.0% per year (the premium relationship 205) and reaching an ultimate premium 105 of $60 at attained age 55 (leveling point 103) can fund a $67,200 benefit policy 201.

### EXAMPLE 2

A worker age 38 (the issue age 203) who is a non-smoker expects to be able to afford a $2,000 annual premium 105 at age 55 (leveling point 103) and chooses a $100,000 benefit. A $550 initial annual premium 101 can fund that schedule 100, assuming a premium relationship 205 of 7.9% premium increase per year.

### EXAMPLE 3

A worker age 48 (the issue age 203) who is a smoker can afford a $1,600 initial annual premium 101 and plans to retire at age 67 (leveling point 103). He chooses a policy with $75,000 benefit 201. Assuming a premium relationship 205 of 6.4% premium increase per year, the ultimate premium 105 in this scenario will be $3,373 per year (from age 67 on).

### EXAMPLE 4

A firm is offering a contributory insurance program for its employees. The coverage provides $25,000 of Policy Benefit 201.

The firm will pay half of the premiums calculated according to the present invention until retirement. Ten years after the policy is activated or when an employee attains age 60 (whichever occurs later), premiums will become level 105, regardless of when the employee retires. The firm's contribution ceases if employment is terminated prior to retirement.

The firm sets the initial premiums 101 by issue age for the premium schedules 100 generated by the present invention. Premiums increase each year and reach the ultimate levels 105 after ten years or the employee reaches age 60 (leveling point 103). The initial 101 and ultimate 105 premiums payable by the employees are shown below in Table 1.

TABLE 1

| | | Monthly Premium | |
|---|---|---|---|
| | Monthly | Between Age 60 | Monthly Premium |
| Issue Age | Initial Premium* | And Retirement* | After Retirement** |
| 30 | $5 | $21 | $42 |
| 35 | $7 | $24 | $48 |
| 40 | $10 | $29 | $58 |
| 45 | $14 | $33 | $66 |
| 50 | $18 | $37 | $74 |
| 55 | $23 | $48 | $96 |
| 60 | $29 | $68 | $136 |

*Matching employer contributions. For issue ages greater than 50, the middle column shows premiums which level after 10 years, not age 60.
**Employee only

The schedules 100 generated according to the present invention allow low contributions by the firm and employees in the early years and delegate the funding to the employees after retirement.

Under the level premium pattern, premiums in the early policy years (except perhaps for the first year) exceed the expected claims plus expenses. Portions of the excess of premiums over claims and expenses are set aside as reserves. These reserves are earmarked to pay claims in the later years when claims exceed premiums and expenses. Such pre-funding will be less for policies generated according to the present invention than corresponding level premium policies.

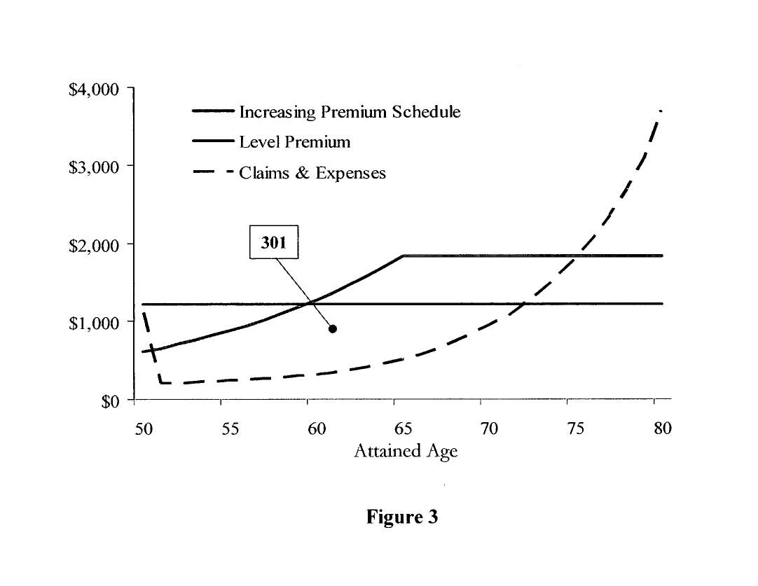

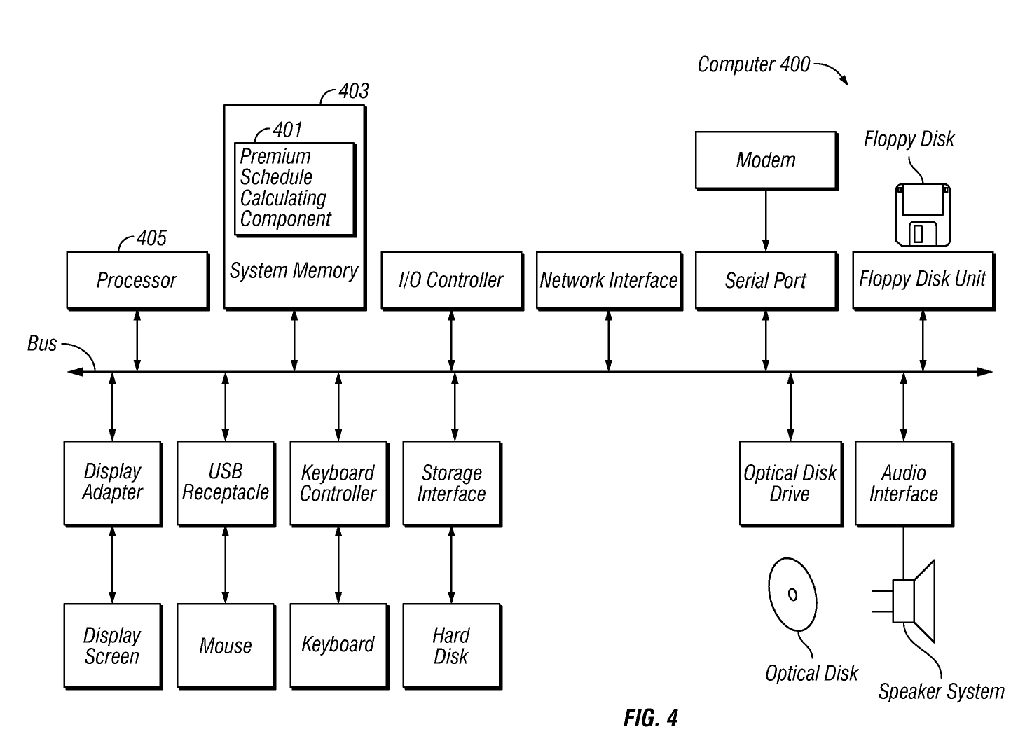

FIG. 3 illustrates the degree of pre-funding 301 during the first 30 years for a policyholder at issue age 50. The amount of pre-funding 301 is represented by the area between the schedule 100 calculated according to the present invention or the level premium and the claims plus expenses.

Relative to level premium policies, the lower pre-funding 301 provides lower costs of coverage for insureds who lapse or claim in the early policy years. Furthermore, lower pre-funding 301 implies lower reserves in the early policy years.

In developing a CI insurance product, an insurer desires a reasonable return on its capital investments. To establish premiums, return is measured recognizing the time value of money. Consequently, profit margins in the early policy years have a greater impact on the return than those in the later years. Thus, because of the lower premiums in the early years when compared to a level premium policy with the same benefits, the return from policies calculated according to the present invention would to be correspondingly lower, all other things being equal.

In setting the target discount value 207, the insurer has two mitigating factors that help to offset the effect of lower initial premiums on margins. First, commissions, as a percentage of premiums, are typically higher in the first policy year than renewal years. On a discounted basis, commissions from the increasing premium schedule 100 calculated according to the present invention will be relatively lower than the corresponding commissions from a level premium structure. Second, the reserves will also be lower, as described above. Since reserves are part of invested assets, lower reserves will also result in lower investment returns. However, the net effect still provides greater margins in the early policy years for policies generated by the invention than for level premium policies.

The present invention makes CI insurance policy premiums more affordable now and later. Individuals who cannot afford the level premiums of current policies with appropriate coverage can purchase the policies generated according to the present invention. The increasing schedules generated by the present invention better match their expected increases in future earning power.

For those who can afford the level premiums but may have to select inadequate coverage, the invention enables them to purchase adequate coverage from the start. Today's CI insurance premium schedules 100 are very rigid, being level and payable for life. A premium schedule 100 generated by the invention can be customized to the purchaser's needs. Moreover, the schedule is known at time of issue so that the purchaser can budget for the future premiums.

The invention can produce a premium schedule 100 that will require less in premiums in the early years than a policy with level premiums. Should the policy lapse in the early years, the policyholder would have paid less in premiums than with a level premium policy for the same coverage. The premium schedule generated by the present invention is beneficial to policyholders as a whole and, as described above, does not result in lower projected returns for the insurer.

It is to be understood that a general purpose computer can be programmed to perform the inventive methodology described herein, and the invention can, but need not, be instantiated in that form. Although performing the underlying calculations manually is possible and is within the scope of the present invention, it is certainly more convenient and practical to program a computer to perform at least the calculation intensive steps of the method. Where this is the case, the inventive methodology can be instantiated as software, hardware, firmware or any combination of these. Where the invention or components thereof are instantiated as software, the software can be in the form of portions in computer memory (e.g., random access memory of a computer executing the software) and/or stored on computer readable media such as magnetic or optical media. Of course, selling or otherwise commercializing insurance policies calculated according to the present invention is within the scope thereof.

As will be understood by those familiar with the art, the invention may be embodied in other specific forms without departing from the spirit or essential characteristics thereof. Likewise, the particular naming and division of the processes, variables, modules, agents, managers, functions, layers, features, attributes, methodologies and other aspects are not mandatory or significant, and the mechanisms that implement the invention or its features may have different names, divisions and/or formats. Accordingly, the disclosure of the present invention is intended to be illustrative, but not limiting, of the scope of the invention, which is set forth in the following claims.

1. A computer implemented method for calculating a flexible, varying insurance program, the method comprising the steps of:
receiving, by a computer, a plurality of input variables, comprising at least an issue age, a targeted present value and a year-to-year premium relationship;
receiving, by the computer, a plurality of process variables;
calculating, by the computer, a non-received process variable, based on received variables; and
calculating, by the computer, the insurance program based on the received variables and the calculated process variable, such that the insurance program includes a schedule of premiums that includes an initial premium, premiums that increase over time after the initial premium and prior to a specific anniversary of the insurance program, and level premiums at a constant value subsequent to the specific anniversary;
wherein the insurance program does not have a cash value and comprises one from a group consisting of: 1) a varying critical illness insurance program, 2) a varying long term care insurance program and chronic care insurance.

2. The method of claim 1, wherein:
the calculating the insurance program includes determining an amount of prefunding based on the schedule of premiums.

3. The method of claim 1, wherein:
the insurance program comprising multiple leveling points.

4. (canceled)

5. The method of claim 1, wherein:
all premiums of the insurance program after the specific anniversary are at the constant value.

6. The method of claim 5, wherein:
the received plurality of process variables comprises three process variables from a group consisting of:
a Policy Benefit,
an initial premium amount,
a leveling point, and
an ultimate level premium; and
the calculating the non-received process variable comprises calculating a fourth process variable of the group based on received input variables and the three received process variables.

7. The method of claim 6 wherein:
the insurance program includes a provision for inflation protection.

8. The method of claim 6 further comprising:
the insurance program is calculated such that benefits and premiums can be frozen at any point in the program.

9.-10. (canceled)

11. A computer readable storage medium storing a computer program product for programming a computer to calculate a flexible, varying insurance program, the computer program product comprising:
program code for accessing a plurality of input variables comprising at least an issue age, a targeted present value and a year-to-year premium relationship;
program code for accessing a plurality of process variables;
program code for calculating a non-received process variable based on received variables; and
program code for calculating the insurance program based on the received variables and the calculated process variable, the insurance program includes a schedule of premiums that includes an initial premium, premiums that increase over time after the initial premium and prior to a specific anniversary of the insurance program, and level premiums at a constant value subsequent to the specific anniversary;
wherein the insurance program does not have a cash value and comprises one from a group consisting of: 1) a varying critical illness insurance program, 2) a varying long term care insurance program and chronic care insurance.

12. The computer program product of claim 11 further comprising:
program code for calculating prefunding during at least one period during which premiums incrementally raise to the constant value.

13.-15. (canceled)

16. The computer program product of claim 15, wherein
the program code for accessing the plurality of process variables includes program code for accessing three process variables from a group consisting of:
a Policy Benefit,
an initial premium amount,
a leveling point, and
an ultimate level premium; and
the program code for calculating a non-received process variable includes program code for calculating a fourth process variable of the group based on received input variables and the three accessed process variables.

17. A computer system for calculating a flexible, varying insurance program, the computer system comprising:
a processor;
computer memory;
the computing system configured to receive a plurality of input variables, comprising at least an issue age, a targeted present value and a year-to-year premium relationship;
the computing system configured to receive a plurality of process variables;
the computing system configured to calculate a non-received process variable based on received variables; and
the computing system configured to calculate the insurance program based on the received variables and the calculated process variable, such that the insurance program includes a schedule of premiums that includes an initial premium, premiums that increase over time after the initial premium and prior to a specific anniversary of the insurance program, and level premiums at a constant value subsequent to the specific anniversary,
wherein the insurance program does not have a cash value and comprises one from a group consisting of: 1) a varying critical illness insurance program, 2) a varying long term care insurance program and chronic care insurance.

18. The computer system of claim 17 further comprising:
the computing system configured to calculate prefunding during at least one period during which premiums incrementally raise to the constant value.

19.-20. (canceled)

21. The computer system of claim 20, wherein:
the received plurality of process variables include three process variables from a group consisting of:
a Policy Benefit,
an initial premium amount,
a leveling point, and
an ultimate level premium; and
the computing system is configured to calculate the non-received process variable by calculating a fourth process variable of the group based on received input variables and the three received process variables.

22.-27. (canceled)

28. A computer implemented method for calculating an insurance program, the method comprising the steps of:
accessing, by a computing system, a plurality of input variables, comprising at least an issue age, a targeted present value and a year-to-year premium relationship;
accessing, by the computing system, a plurality of process variables; and
calculating, by the computing system based on the input variables and the process variables, a schedule of premiums that includes an initial premium, premiums that increase over time after the initial premium and prior to a specific anniversary of the insurance program and level premiums at a constant value subsequent to the specific anniversary.

29. A computer implemented method of claim 28, further comprising:
calculating, by the computing system, a non-received process variable, based on received variables, the schedule of premiums is calculated based on the calculated non-received process variable.

30. A computer implemented method of claim 29, wherein:
the received plurality of process variables comprises three process variables from a group consisting of: a Policy Benefit, an initial premium amount, a leveling point, and an ultimate level premium; and
the calculating the non-received process variable comprises calculating a fourth process variable of the group based on received input variables and the three received process variables.
